(19) United States
(12) Patent Application Publication
(10) Pub. No.: US 2008/0185460 A1
(43) Pub. Date: Aug. 7, 2008

(54) Fuel Injection Valve

(75) Inventors: Yoshihiko Onishi, Tokyo (JP); Shigenobu Tochiyama, Tokyo (JP); Mamoru Sumida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/596,671

(22) PCT Filed: Jul. 29, 2005
(86) PCT No.: PCT/JP05/13923

§ 371 Date: Nov. 16, 2006

(51) Int. Cl. B05B 1/30

(52) U.S. Cl. 239/584

(57) ABSTRACT

Stable spray characteristics (particle size, directivity, divergence angle of spray, and penetration force) are provided for individual nozzle holes, flows of fuel toward the nozzle holes are not interfered with each other, and further spray characteristics can arbitrarily be altered at respective nozzle holes.

A whirler 11 for providing a whirling force to fuel is provided, and a whirl flow is formed in a cavity 20 downstream of a seal portion of a needle valve 16. A plurality of nozzle holes 13 are formed in an orifice plate 14, and openings on the cavity 20 side of the nozzle holes 13 are formed on substantially the same diameter with respect to the central axis of a fuel injection valve 1. Thus it becomes possible to cause fuel having inflow angle and high flow velocity to flow into the openings of the nozzle holes 13. Furthermore, in the vicinity of the openings of the nozzle holes 13, fuel having high flow velocity flows in only on one side with respect to the cross section of the nozzle holes, so that contraction flow is generated in the nozzle holes 13, and atomization is achieved as well.

### TECHNICAL FIELD

The present invention relates to a fuel injection valve.

### BACKGROUND ART

As a conventional fuel injection valve making direct injection into a cylinder, there has been proposed a fuel injection valve that is capable of making injection with respect to any target position, without being affected by air flow in the cylinder, and further that includes a plurality of nozzle holes each having a small diameter. In such a fuel injection valve, to make smooth injection with respect to respectively different target positions, the configuration of a cavity, which is situated from a seal portion of a valve to numerous nozzle holes, and the direction of nozzle holes are varied.

However, in such a case, depending on layout of respective nozzle holes and direction of respective nozzle holes, there are different flows of fuel flow from the cavity to the nozzle holes. Consequently, to obtain stable spray characteristics (particle size, directivity, divergence angle of spray, and penetration force) at respective nozzle holes, it is necessary to repeat test or the like, thus a large number of time is required.

For example, there has been conventionally proposed a fuel injection valve, which comprises a valve body including a hole and a cavity that are formed in a valve seat, a plate that is joined to the cavity by welding, as well as includes a plurality of nozzle holes, and a valve element that moves up and down along the central axis of the valve body to open and close the hole, and in which the atomization of spray is achieved by designing the structures of the nozzle hole plate and the cavity (refer to Patent Document 1).

In such a fuel injection valve, when setting the configuration of nozzle holes and the angle of the nozzle holes individually at respective nozzle holes, the flows of fuel from the cavity to the nozzle holes will be changed at each of the nozzle holes respectively. Hence a problem exists in that the nozzle holes have respectively different spray characteristics (particle size, directivity, divergence angle of spray, and penetration force).

Furthermore, there has been proposed another fuel injection nozzle in which whirling means is located at the end portion of a needle (refer to Patent Document 2).

In this case, even if a whirling force is generated in fuel, since the nozzle holes are positioned in the center of a cavity, it is difficult to construct the nozzle holes for making injection with respect to different positions. Furthermore, the strength of a whirling force is largely affected by a centrifugal force, so that the whirling force comes to be smaller in the central portion of the cavity. Moreover, the diameter of nozzle holes is apparently smaller as compared with the diameter of a cavity, and thus a whirling force having been generated in the cavity is largely decreased when fuel flows into the nozzle holes. Consequently, a problem exists in that effective whirling force cannot be obtained.

Moreover, there has been provided a fuel injection valve in which a plurality of nozzle holes are formed in a measuring plate, as well as a whirl flow-generating groove is formed on the top of the measuring plate (refer to Patent Document 3).

Providing only such a whirl flow-generating groove raises the possibility that there is some fuel not passing through the whirl flow-generating groove, but flowing directly into nozzle holes. Furthermore, in the case where there is provided any whirl flow-generating groove in order to generate the whirl flow upstream of respective nozzle holes, when a nozzle hole pitch is made small, flows of fuel toward the adjacent nozzle holes are interfered with each other. Thus, a problem exists in the occurrence of fluctuation in characteristics.

Further, it becomes necessary that the whirling groove and nozzle holes be formed in the same measuring plate, thus arising a dimensional problem that the nozzle hole pate comes to be larger. Then, in case of a large nozzle hole plate, the area presented to pressure is increased when it is used under high fuel pressure. Consequently, a further problem exists in lower reliability.

Patent Document 1: the Japanese Patent No. 3655905

Patent Document 2: the Japanese Patent Publication (unexamined) No. 158989/1996

Patent Document 3: the Japanese Patent Publication (unexamined) No. 340121/2004

### DISCLOSURE OF INVENTION

### Problems to be Solved by the Invention

The problem to be solved is that stable spray characteristics (particle size, directivity, and penetration force) cannot be obtained at respective nozzle holes, and flows of fuel toward respective nozzle holes are interfered with each other. Moreover, a further problem exits in that spray characteristics cannot be arbitrarily changed at respective nozzle holes.

### Means for Solving the Problems

In the present invention, there is provided a member giving a whirling force to fuel, the whirl flow is formed in a cavity downstream of a seal portion of a valve, and all nozzle holes are disposed at positions of substantially the same diameter on the outer circumferential portion of the cavity where velocity of the flow is high. As a result of such a construction, it becomes possible to cause fuel of high flow velocity having an inflow angle to flow into openings of the nozzle holes.

In this construction, the inflow area of fuel when flowing into the openings of the nozzle holes comes to be smaller, and further the flow velocity thereof at the time of flowing into the nozzle holes becomes higher. Furthermore, in the vicinity of the openings of the nozzle holes, fuel having higher flow velocity flows only in one side with respect to the cross section of the nozzle holes, so that a contraction flow is generated in the nozzle holes, and further atomization is achieved as well. This phenomenon occurs only in the openings of the nozzle holes. Even if the direction of nozzle holes is changed, the same effect can be obtained.

Thus, in the case of relatively low pressure of fuel, even when nozzle hole directions are set with respect to predetermined respectively different targets, it is possible for respective nozzle holes to easily obtain stable spray characteristics (particle size, directivity, and penetration force).

### ADVANTAGEOUS EFFECTS OF THE INVENTION

According to the invention, an advantage exists in that, in spite of different target positions to be subjected to injection at respective nozzle holes, it is possible to suppress fluctuation in spray characteristics (particle size, directivity, divergence angle of spray, and penetration force) at respective nozzle holes, and to easily obtain a stable spray. Furthermore, in the conventional apparatuses, the generation of high fuel pressure (for example, 20 Mpa) is required to carry out atomization. Whereas, according to the invention, a further advantage exists in that about the same level of effect as that of the conventional apparatuses can be obtained under lower fuel pressure (for example, 12 Mpa).

### BEST MODE FOR CARRYING OUT THE INVENTION

### Embodiment 1

A preferred embodiment according to the present invention is hereinafter described with reference to the drawings.

FIG. 1 is a cross sectional view showing a fuel injection valve according to a first embodiment of the invention. FIG. 2 is a cross sectional view showing an end portion. In the drawings, a fuel injection valve 1 is constructed of a solenoid device 2 acting to generate an electromagnetic force and a valve main body 3. In the solenoid device 2, a core 4 being a stator iron core, a ring 5 that is made of non-magnetic material, a holder 6 and a housing 7 form a magnetic circuit; and a coil 9 that is connected to a terminal 8 is contained therein.

In the valve main body 3, there is provided a valve body 10. To this valve body 10, a whirler 11 acting to generate a whirling force in fuel, a valve seat 12 including a seat portion 12a and a cylindrical portion 12b, as well as an orifice plate 14 that includes a plurality of nozzle holes 13 and measures the quantity of flow, are fixed.

A needle valve 16, being a valve element including an armature 15 acting as a moving iron core is supported in a slidable manner in the valve body 10 and the whirler 11. By this needle valve 16 moving up and down, the valve is opened and closed. The compressive force of a spring 17, which is located in an internal part of the core 4, is adjusted by means of a rod 18. Sealing properties of the valve element 16 are determined by the compressive force provided by the spring 17 and the fluid force that is generated by the fact that the pressure of fuel is applied to the valve element 16.

In response to a valve-opening signal from a control device, not shown, due to the fact that current is carried through the coil 9, the armature 15, being a moving iron core, is attracted to the core 4, being a fixed iron core. Then, at a time point when this attraction is larger than the compressive force provided by the spring 17 and the fluid force generated by fuel pressure, the valve is open. At this time, as to an opening area of the seat portion 12a, a lift amount of the needle 16 is a distance until the needle 16 comes in contact with a stopper 19, so that the opening area of the seat portion 12a is determined by this lift amount. At the time of valve closing, current having been carried through the coil 9 is interrupted, and thus the valve comes to be closed due to the compressive force provided by the spring 17.

As for the flow of fuel herein, fuel, to which pressure has been applied to a higher pressure by means of a fuel pump, not shown (for example, a fuel pressure is 12 Mpa), is fed to the fuel injection valve 1 through a delivery pipe, not shown. At the time of valve closing, an internal part of the fuel injection valve 1 is filled with a high-pressure fuel up to the needle valve 16 and the seat portion 12a of the valve seat 12. With valve opening signal from the control device, not shown, the needle 16 is lifted to valve-open position, and first a high-pressure fuel flows into a cavity 20 that is formed of the valve seat 12 downstream of the seat portion 12a, and the orifice plate 14. After the cavity 20 has been filled with the high-pressure fuel, the fuel is injected toward respective predetermined target positions from the nozzle holes 13 respectively.

FIG. 3 is a cross sectional view showing the end portion of a fuel injection valve for explaining the situation of the flow of fuel. FIG. 4 is a cross sectional view taken along the line A-A of FIG. 3. The fuel flowing in an internal part of the fuel injection valve 1 is provided with a strong whirling force while passing through the whirler 11 functioning to generate the whirl flow, and flows into the cavity 20 via the needle valve 16 and the seat portion 12a of the valve seat 12. At this time, the stable whirl flow will be generated in the entire cavity 20. The fuel having been provided with the whirling force, then, comes to be a helical flow due to a centrifugal force, and pressed to the outer circumferential portion. The flow velocity of fuel becomes the maximum in the vicinity of the outer circumference of the cavity 20.

According to the invention, openings of respective nozzle holes 13 facing to the cavity 20 are formed at the outer circumferential portion on the downstream side of the cavity 20, so that fuel having a certain amount of inflow angle and the maximum velocity flows into the openings of the nozzle holes 13. That is, fuel including the main flow that is formed in the entire cavity 20 and is stable, comes to flow in each of the nozzle holes 13. FIG. 5(a) is a plan view showing the opening of a nozzle hole 13. FIG. 5(b) is a perspective view showing the nozzle hole 13. FIG. 6(a) is a plan view showing the opening according to a conventional nozzle hole. FIG. 6(b) is a perspective view showing the conventional nozzle hole.

As shown in FIG. 5, fuel flows into the nozzle holes 13 in the direction of being away from the center of the fuel injection valve 1, so that in the vicinity of the opening of the nozzle holes 13 on the cavity 20 side, the flow velocity on the wall of the side where fuel flows in becomes higher, and the flow velocity on the opposite side thereof is lower. The fuel comes to be in the state of being agitated in the internal part of the nozzle holes 13.

According to the invention, flow rate is measured by means of the orifice plate 14, and pressure loss that is generated in the internal part of a fuel injection valve 1 comes to be the maximum in the nozzle holes 13. Accordingly, even if fuel flows out from the nozzle holes 13, the whirl flow in the cavity 20 is not affected. Therefore, fuel flows into respective nozzle holes 13 in a stable manner irrespective of the angle from an opening to an outlet. Thus, even if the direction of nozzle holes 13 is changed, only a direction with respect to any target position comes be changed, thus making it possible to easily set the nozzle holes 13 corresponding to individual target positions respectively without affecting fuel spray characteristics (particle size, divergence angle of spray, and penetration force). In this manner, it is possible to set various spray characteristics by arbitrarily setting angles from the opening to the outlet of respective nozzle holes 13.

Due to the fact that fuel flows in the internal part of nozzle holes 13, it becomes possible to atomize fuel with low fuel pressure as compared with the conventional apparatuses. Further, as shown in FIG. 2, the cavity 20 is so configured that the inside diameter of the substantially cylindrical portion 12b is set to be smaller than the diameter of the seat portion 12a, being a point of contact with the needle valve 16, and that the diameter φe of the valve seat 12 and the orifice plate 14 being in contact is smaller than the inside diameter of the substantially cylindrical portion 12b, whereby the channel area comes to be smaller by degrees toward the outer circumferential side, that is, for example, the cavity 20 is structured so as to be tapered on the downstream side.

Thus, it is possible that fuel having been pressed to the outer circumferential surface of the cavity 20 is further pressurized by the centrifugal force, and that the inflow angle of fuel is made larger with respect to the axis of respective nozzle holes 13. Consequently, it is possible to achieve further atomization of fuel.

FIGS. 7(a) and (b) are enlarged cross sectional views showing a tapered portion. FIG. 7(a) is an enlarged cross sectional view showing the tapered portion shown in FIG. 2. As shown in FIG. 7(b), the junction between the substantially cylindrical portion 12b and the tapered portion is constructed to be arc-shaped, and smoothly connected, thereby enabling to suppress the generation of fuel coming off when fuel flows from the substantially cylindrical portion 12b to the tapered portion. Owing to such construction, it is possible to make larger the fuel pressure and the flow velocity in the vicinity above the nozzle holes 13, thus making it possible to achieve further atomization of fuel.

Due to the construction as described above, conventionally the fuel pressure of approximately 20 Mpa is required, while according to the invention, about the same level of effect can be obtained with the fuel pressure of approximately 12 Mpa.

FIG. 8 is a cross sectional view showing the end portion of a fuel injection valve. FIG. 9 is a cross sectional view taken along the line B-B of FIG. 8. In the drawings, C is a taper angle; g is an angle of inclination of the nozzle holes 13 with respect to the axial direction of a valve; m is an angle of inclination of the nozzle holes 13 with respect to the radial direction; φd is a pitch diameter of the nozzle holes 13; φe is a diameter of the contact part between the valve seat 12 and the orifice plate 14; φf is an inside diameter of the substantially cylindrical portion 12b; φh is an inside diameter of the nozzle holes 13; j is a gap between the outermost diameter of the nozzle holes 13 and the contact diameter φe; and k is a distance between pitches of the nozzle holes 13.

The flow velocity and the angle of inclination of fuel in the internal part of the cavity 20, as well as the pressure of fuel above the nozzle holes 13 are affected by the configuration of the substantially cylindrical portion 12b, the taper angle C, and the pitch diameter φd of the nozzle holes 13. For example, in the case where a taper angle C is small, the fuel pressure above the nozzle holes 13 is reduced. On the contrary, in the case where the taper angle C is large, the resistance when fuel runs against the wall of the cavity 20 becomes larger, so that the flow velocity does not come to be larger.

Furthermore, the same problem as described above arises also in a ratio between the inside diameter of the substantially cylindrical portion 12b and the pitch diameter φd of the nozzle holes 13. It has been acknowledged from test results that the balance between the fuel pressure and the flow velocity is appropriately achieved in the case in which a taper angle C is 120° to 150°.

Supposing that the contact part between the valve seat 12 and the orifice plate 14, and the outermost diameter portion of the nozzle holes 13 come close, a problem exists in that the velocity of fuel is decreased due to resistance on the wall in the vicinity of the wall of the cavity 20. To cope with this, it is necessary to provide a certain difference between the contact diameter φe between the valve seat 12 and the orifice plate 14, and the pitch diameter φd1 of the outermost diameter of the nozzle holes 13.

It has been acknowledged from test results that, as the above-mentioned difference, setting a difference of about the nozzle diameter φh is required. In addition, it has been acknowledged from test results that setting a ratio between the inside diameter φf the substantially cylindrical portion 12b and the pitch diameter φd of the nozzle holes 13 to be 1.5 to 2.0 is suitable. Further, it is necessary that the pitch diameter φd2 of the innermost diameter in the opening of the nozzle holes 13 facing the cavity 20 side is formed larger than the inside diameter Of the substantially cylindrical portion 12b. Such construction is employed because of smaller effect of the centrifugal force, and lower flow velocity within the range of the inside diameter φf of the substantially cylindrical portion.

Moreover, the cavity 20 is formed on the downstream side of the seat portion 12a, so that when the capacity of the cavity 20 is made larger, it will take a long time period for the cavity 20 to be filled with high-pressure fuel. Hence, a problem exists in a longer time period until fuel injection. Furthermore, after a valve has been opened, a problem exists in that the fuel left in the cavity 20 drips in the internal part of the cylinder of an engine. It has been acknowledged that forming the inside diameter φf of the substantially cylindrical portion 12b in the cavity 20 to be in the range of 0.6 mm to 1.0 mm is suitable.

Further, when the cross section of the substantially cylindrical portion 12b comes to be small as compared with the gross sectional area of the nozzle holes 13, the whirling force of fuel will be reduced. Therefore, it is necessary that the cross section of the cylindrical portion 12b is not less than 1.5 times the gross sectional area of the nozzle holes 13.

As to the layout of nozzle holes 13, when a distance k between pitches of the adjacent nozzle holes is a small value, fuel to flow into the adjacent nozzle holes 13 will be interfered with each other, and thus fluctuation in inflow angle and flow velocity of fuel to flow into the nozzle holes 13 may take place between the nozzle holes 13. Consequently, fluctuation in spray characteristics will also arise, so that it is necessary that the distance k between pitches of the nozzle holes 13 is set to be not less than 2.5 times the nozzle hole diameter φh.

FIG. 10, in the case of letting the diameter of nozzle holes 13 D (=φh), and the length of nozzle holes 13 L, is a graph showing a relationship between L/D and spray characteristics (particle size, divergence angle of spray, and penetration force). As shown in FIG. 10, it is understood that particle size characteristics and a penetration force are improved, while a divergence angle of spray becomes smaller when L/D comes to be larger. Thus, it will be necessary to adjust L/D depending on specification of engine.

According to the invention, as is understood from the situation of flow in the internal part of the nozzle holes 13 shown in FIG. 5, the flow of fuel to be formed in the outlet of the nozzle holes 13 will be varied by changing the setting of L/D. Accordingly, just changing L/D enables to alter spray characteristics (particle size, divergence angle of spray, and penetration force) in the relatively wide range.

With regard to the design of a cylinder injection engine, for example, in a center-injection system in which the fuel injection valve 1 is located in the center of an engine, a distance from the fuel injection valve 1 to an ignition plug is short (e.g., approximately 15 mm). L/D is set to be small, whereby fuel is made to spray before it is rectified in the internal part of the nozzle holes 13, thus making it possible to form a spray pattern in which penetration force is suppressed, and divergence angle of spray is large.

Meanwhile, in a side-injection system in which the fuel injection valve 1 is located on the side of an engine, a distance from the fuel injection valve 1 to an ignition plug becomes longer (for example, approximately 40 mm). L/D is set to be larger, whereby fuel is made to spray in the state of being rectified to a certain degree in the internal part of the nozzle holes 13, thus making it possible to form a spray pattern of large penetration force, and narrow spray angle. In the valve according to the invention, it is suitable that L/D is set to be about 2 to 4 in the former system, and L/D is set to be about 4 to 6 in the latter system.

Concerning the layout of the nozzle holes 13, it is possible to adjust angles of the nozzle holes 13 so that lines made by extending the center lines of respective nozzle holes 13 from the outlets are not crossed over each other. By employing such a construction, there will be no collision of fuel having been sprayed from each of the nozzle holes. Then, a single outlet corresponds to a single target position, resulting in higher efficiency.

### Embodiment 2

FIG. 11 is a cross sectional view showing an end portion of a fuel injection valve according to a second embodiment of the invention. According to this second embodiment, there is provided a concave 14C in a part of the orifice plate 14, whereby a length L of a part of nozzle holes 13 is constructed to be different from length of the other nozzle holes. This construction changes L/D, so that it is possible to alter spray characteristics of the part of the nozzle holes 13.

### Embodiment 3

FIG. 12 is a cross sectional view showing an end portion of a fuel injection valve according to a third embodiment of the invention. According to this third embodiment, a valve seat and an orifice plate are configured to be an integral whole, and nozzle holes 13 are formed in the valve seat 12. Due to this construction, although the setting range of a spray pattern to be formed with respective nozzle holes 13 comes to be narrower, it is possible to reduce the number of parts, and to achieve cost reduction.

### Embodiment 4

FIG. 13 is a cross sectional view showing an end portion of a fuel injection valve according to a fourth embodiment of the invention. According to this fourth embodiment, there are provided whirling grooves 21 in a part of the needle valve 16. Due to the formation of whirl-generating means at the needle valve 16 as described above, it is possible to provide the same advantage as in the foregoing first embodiment.

### BRIEF DESCRIPTION OF THE DRAWINGS

FIG. 1 is a cross sectional view showing a fuel injection valve (Embodiment 1);

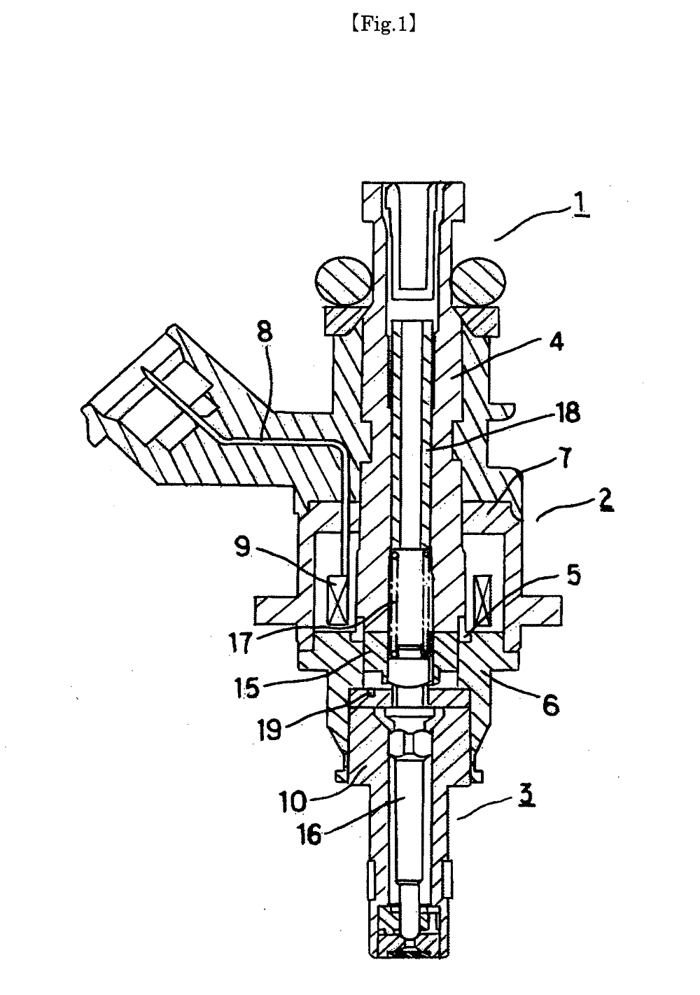

FIG. 2 is a cross sectional view showing an end portion of the fuel injection valve (Embodiment 1);

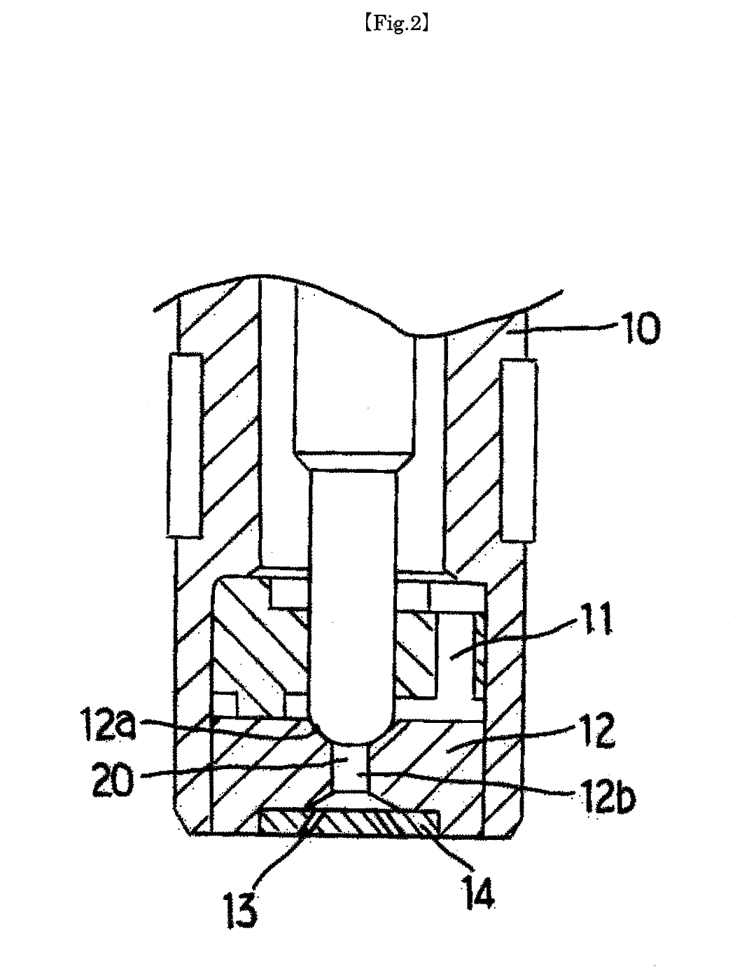

FIG. 3 is a cross sectional view showing an end portion of the fuel injection valve (Embodiment 1);

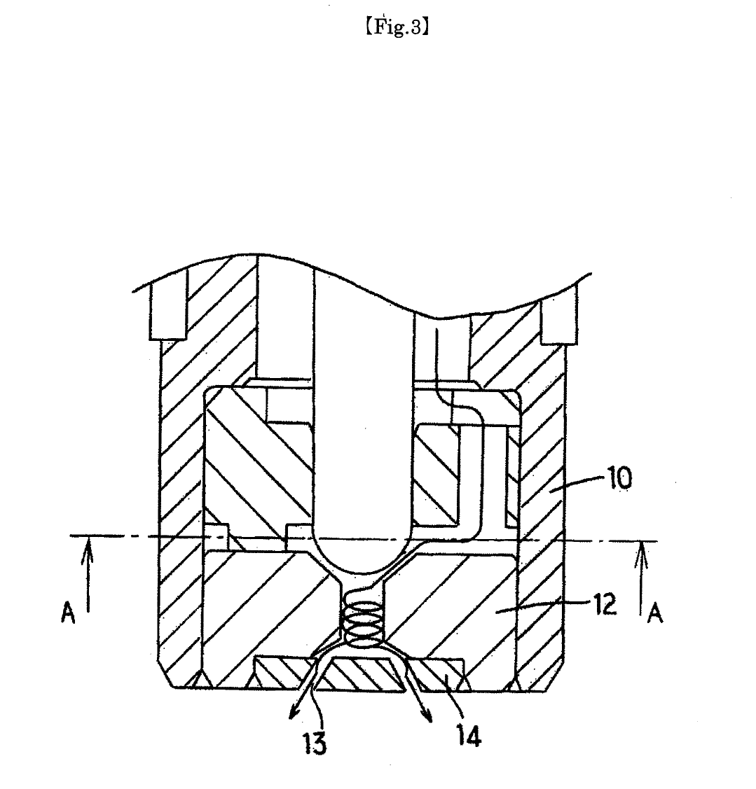

FIG. 4 is a cross sectional view taken along the line A-A of FIG. 3 (Embodiment 1);

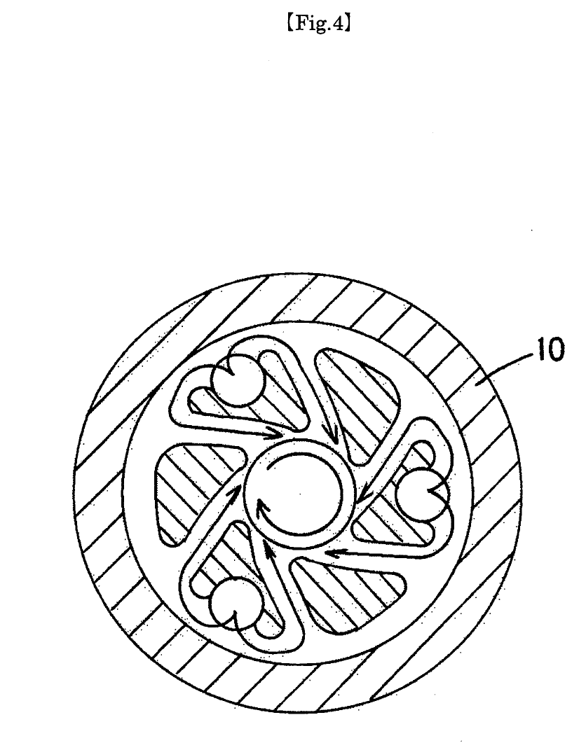

FIG. 5 is a plan view showing an opening of a nozzle hole (a), and a perspective view showing the nozzle hole (b) (Embodiment 1);

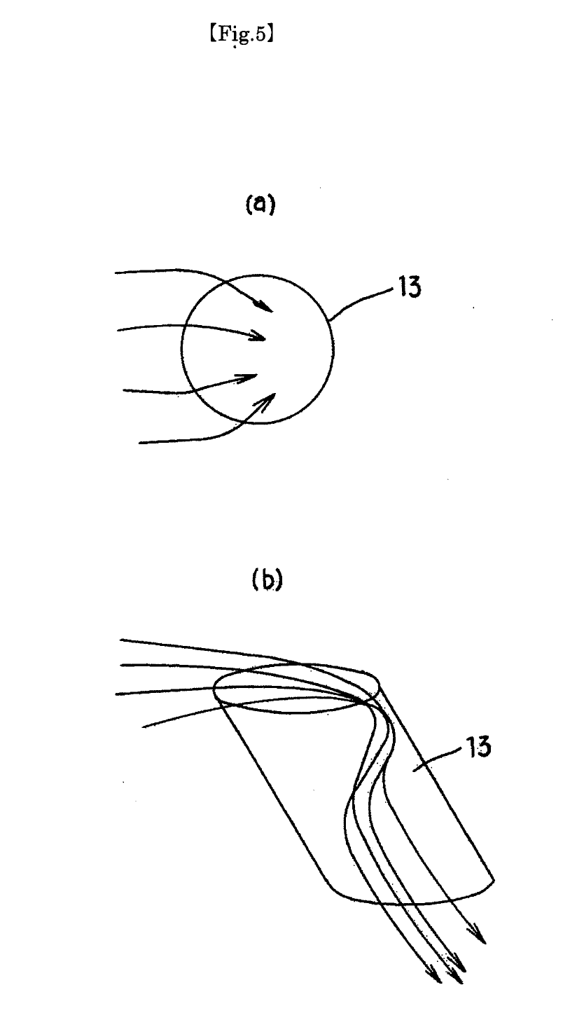

FIG. 6 is a plan view showing an opening of a conventional nozzle hole (a), and a perspective view showing the nozzle hole (b);

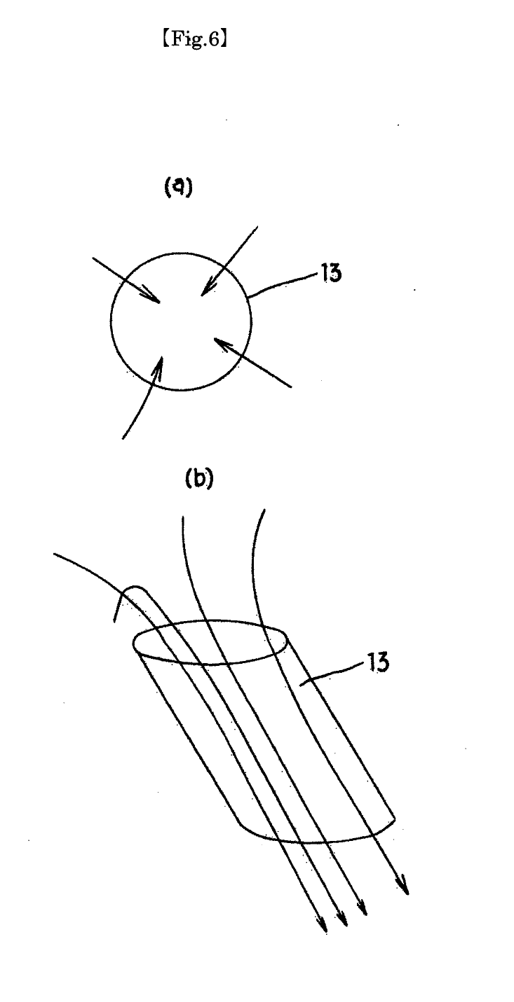

FIG. 7 is an enlarged cross sectional view showing the tapered portion (Embodiment 1);

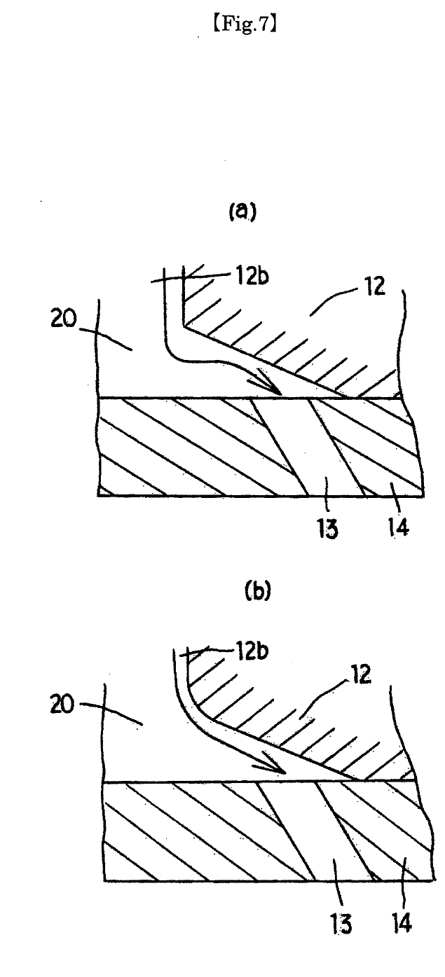

FIG. 8 is a cross sectional view showing the end portion of the fuel injection valve (Embodiment 1);

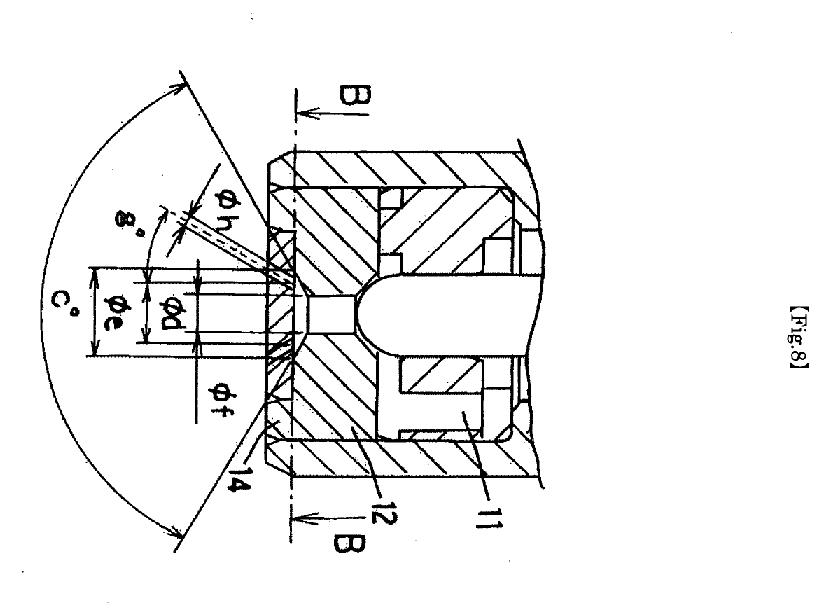

FIG. 9 is a cross sectional view taken along the line B-B of FIG. 8 (Embodiment 1);

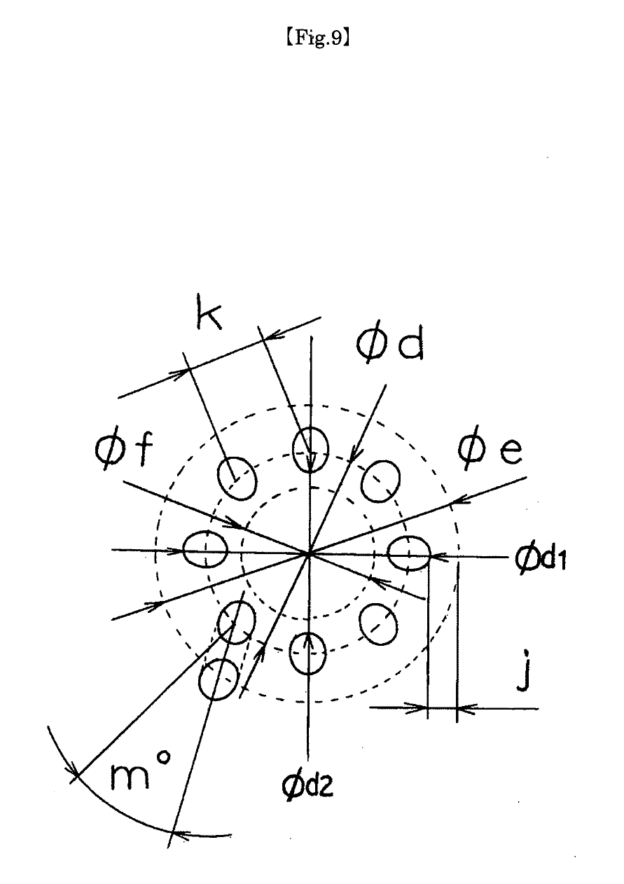

FIG. 10 is a graph showing the relationship between L/D and spray characteristics;

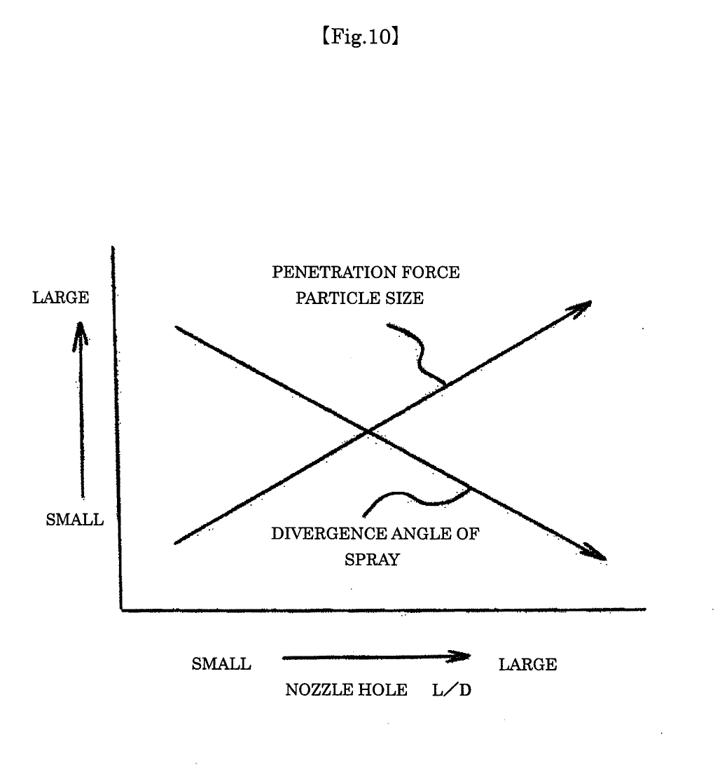

FIG. 11 is a cross sectional view showing an end portion of a fuel injection valve (Embodiment 2);

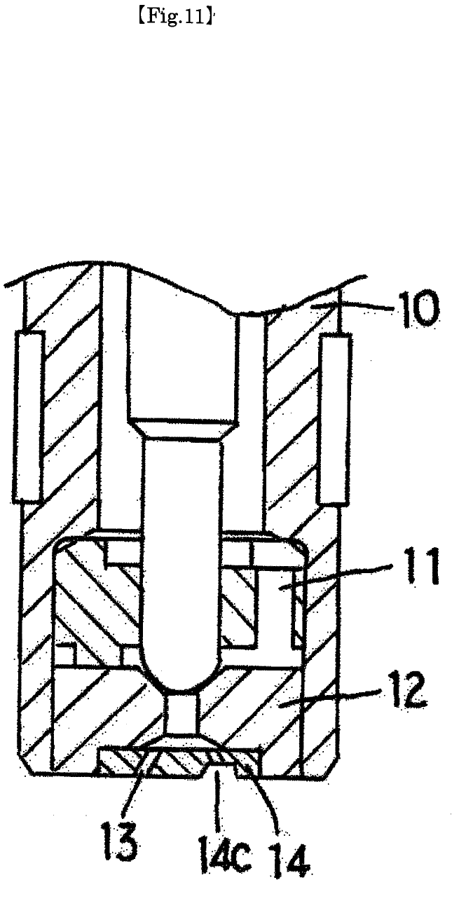

FIG. 12 is a cross sectional view showing an end portion of a fuel injection valve (Embodiment 3); and

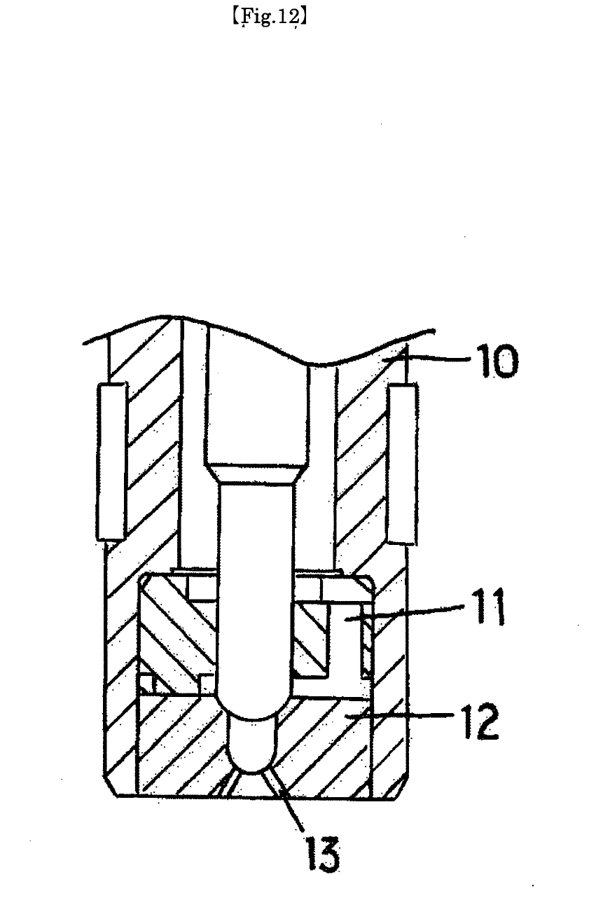

FIG. 13 is a cross sectional view showing an end portion of a fuel injection valve (Embodiment 4).

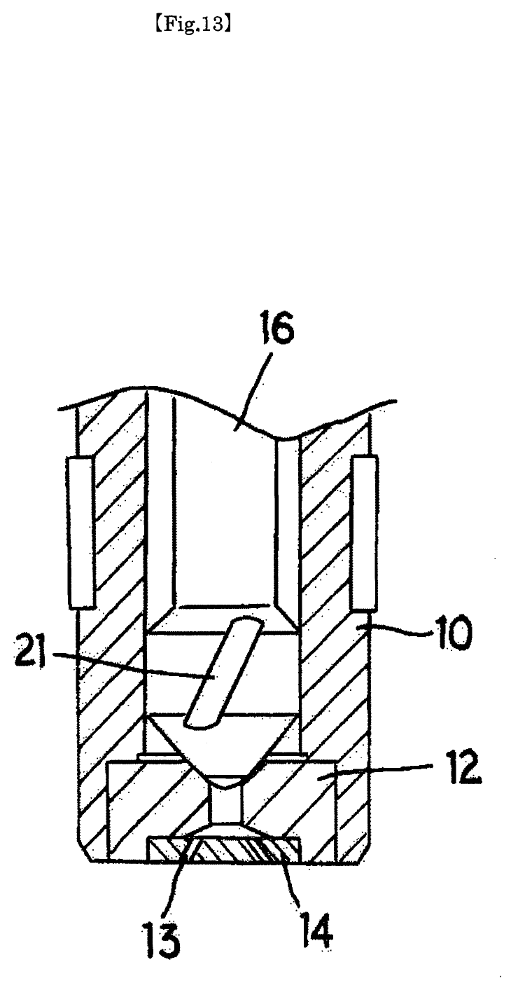

### DESCRIPTION OF REFERENCE NUMERALS

1: fuel injection valve
2: solenoid device
10: valve body
11: valve seat
12b: substantially cylindrical portion
13: nozzle hole
14: orifice plate
16: valve element
20: cavity

1-15. (canceled)

16. A fuel injection valve including: a valve element supported to be capable of sliding in an internal part of a valve body; a valve seat with which said valve element is apart from or in contact; a whirling means that is disposed on the upstream side of said valve seat, and that provides a whirling force to fuel; and a solenoid device for causing said valve element to operate;
wherein the downstream-side end face of said valve seat and an orifice plate are fixed in close contact, whereby a cavity is formed; and a plurality of nozzle holes are provided in said orifice plate, and openings on said cavity side of said nozzle holes are formed substantially on the same diameter with respect to a central axis of the fuel injection valve.

17. The fuel injection valve according to claim 16, wherein said nozzle holes are formed at any angle.

18. The fuel injection valve according to claim 16, wherein an inside diameter of a substantially cylindrical portion that is formed in said valve seat is formed to be smaller than a seat diameter, and a contact diameter between said valve seat and said orifice plate is formed to be larger than an inside diameter of said substantially cylindrical portion, thereby being constructed such that a channel area comes to be smaller by degrees toward the outer circumferential side.

19. The fuel injection valve according to claim 18, wherein said cavity is constructed in a tapered configuration on the downstream side.

20. The fuel injection valve according to claim 19, wherein the junction between said substantially cylindrical portion and tapered portion are formed to be a circular arc.

21. The fuel injection valve according to claim 19, wherein a taper angle is formed to be 120° to 150°.

22. The fuel injection valve according to claim 16, wherein a pitch diameter of the innermost diameter of the openings of said nozzle holes facing to said cavity side is formed to be larger than an inside diameter of said substantially cylindrical portion formed in said valve seat, and a contact diameter between said valve seat and said orifice plate is formed to be larger than a pitch diameter of the outermost diameter of said openings.

23. The fuel injection valve according to claim 22, wherein a difference between the contact diameter between said valve seat and said orifice plate, and the pitch diameter of the outermost diameter of said openings is substantially a nozzle hole diameter.

24. The fuel injection valve according to claim 16, wherein the inside diameter of said substantially cylindrical portion formed in said valve seat is formed to be 0.6 mm to 1.0 mm, and the pitch diameter of said nozzle holes is formed to be 1.5 to 2.0 times the inside diameter of said substantially cylindrical portion.

25. The fuel injection valve according to claim 16, wherein a distance between pitches of said nozzle holes facing to said cavity side is not less than 2.5 times said nozzle hole diameter.

26. The fuel injection valve according to claim 16, wherein said nozzle holes are disposed so that lines made by extending center lines of said nozzle holes from outlets are not crossed over each other.

27. The fuel injection valve according to claim 16, wherein said valve seat and said orifice plate are formed to be an integral whole.

28. The fuel injection valve according to claim 16, wherein, in the case where the fuel injection valve is mounted on the center of an engine, when letting a diameter of said nozzle holes D and a length of said nozzle holes L, it is constructed to be 2≦L/D≦4.

29. The fuel injection valve according to claim 16, wherein, in the case where the fuel injection valve is mounted on the side of an engine, when letting a diameter of said nozzle holes D, and a length of said nozzle holes L, it is constructed to be 4≦L/D≦6.

30. The fuel injection valve according to claim 16, wherein a whirling groove is provided at a part of said valve element.
